(19) United States
(12) Patent Application Publication
(10) Pub. No.: US 2020/0337264 A1
(43) Pub. Date: Oct. 29, 2020

(54) System and Method for Cooling a Pet Bed

(71) Applicant: Anne Elizabeth Mahoney, Athens, GA (US)

(72) Inventor: Anne Elizabeth Mahoney, Athens, GA (US)

(21) Appl. No.: 16/394,329

(22) Filed: Apr. 25, 2019

(51) Int. Cl. A01K 1/00; A01K 1/035

(52) U.S. Cl. CPC A01K 1/0082; A01K 1/0076; A01K 1/0353

(57) ABSTRACT

Exemplary embodiments of a system for cooling a pet bed are disclosed. Certain embodiments include a portable ice chest comprising a false bottom surface that defines an upper volume and a lower volume within the portable ice chest. The false bottom surface may comprise a plurality of holes (or pathways) for allowing water to drain from the upper volume which is configured to store ice to the lower volume which is configured to serve as a reservoir for the water. A pump located within the lower volume of the portable ice chest is configured to circulate water from the lower volume of the portable ice chest, through a heat exchanger subsystem that is external to the portable ice chest, and back to the lower volume. The heat exchanger subsystem may be contained within a pet bed component of the system.

### BACKGROUND

The present invention relates to pet bedding solutions and, more particularly, to a novel system for leveraging cool liquid held in a portable cooler to charge a heat exchange subsystem incorporated in a pet bed.

Outdoor activities commonly involve all members of a family, even the family pet. A trip to the beach, the park, the lake, or just the backyard could require all kinds of preparations to ensure that all involved have an enjoyable experience. All involved in the outdoor festivities need to stay hydrated and, so, a cooler filled with drinks and ice is all but ubiquitous for many outdoor activities. And, the comfort of the family pet needs to be accommodated, so it's not unusual for a pet bed to be brought along with all the other supplies.

During outdoor activities, the family pet often finds itself suffering in silence—panting away in an effort to regulate body temperature. A cooler full of melted ice water next to a comfortable pet bed, however, presents an opportunity to provide the family pet with some thermal relief. Therefore, there is a need in the art for a system and method that leverages the cool water so often held in a cooler to circulate through a heat exchanger incorporated in a pet bed. More specifically, there is a need in the art for a system that tethers to a cooler, such as an Igloo® or Yeti® cooler, a heat exchanger subsystem integrated into a pet bed such that thermal energy generated by a pet lounging on the pet bed may be efficiently dissipated.

### SUMMARY

Exemplary embodiments of a system for cooling a pet bed are disclosed. Certain embodiments include a portable ice chest comprising a false bottom surface that defines an upper volume and a lower volume within the portable ice chest. The false bottom surface may comprise a plurality of holes (or pathways) for allowing water to drain from the upper volume which is configured to store ice to the lower volume which is configured to serve as a reservoir for the water. A pump located within the lower volume of the portable ice chest is configured to circulate water from the lower volume of the portable ice chest, through a heat exchanger subsystem that is external to the portable ice chest, and back to the lower volume. The heat exchanger subsystem may be contained within a pet bed component of the system.

Certain embodiments may include a controller configured to manage a power supply to the pump based on signals received from a water level switch, water level sensor, temperature sensor, or the like. In this way, the controller may vary a frequency of the power supply to the pump such that a speed of the pump is varied. Or, depending on embodiment, the controller may switch the power supply to the pump from an energized state to a non-energized state (i.e., “turn” the pump “on” and/or “off”). The heat exchanger subsystem may comprise a flexible, thermally conductive tubing in fluid communication with the pump as well as a thermally conductive surface in mechanical communication with the flexible, thermally conductive tubing. In this way, the heat exchanger subsystem may provide for efficient thermal energy transfer from a pet lounging on the pet bed to the water circulating through the subsystem.

### BRIEF DESCRIPTION OF THE DRAWINGS

FIG. 1 illustrates an exemplary embodiment of a pet bed cooling system according to the solution;

FIG. 2 illustrates certain aspects of the system shown in FIG. 1 relative to the cooler component; and

FIG. 3 is a functional block diagram of exemplary components of an embodiment of the solution for a pet bed cooling system.

### DETAILED DESCRIPTION

Various embodiments, aspects and features of the present invention encompass a system and method for cooling a pet bed. As will be better understood from the attached figures and the following description, a portable ice chest or cooler my be configured or retrofitted such that cold water contained within the cooler is circulated through a pet bed and returned to the cooler reservoir. In this way, a heat exchanger subsystem incorporated in the pet bed may be charged with the cold water, thereby providing a cool bedding surface for a pet.

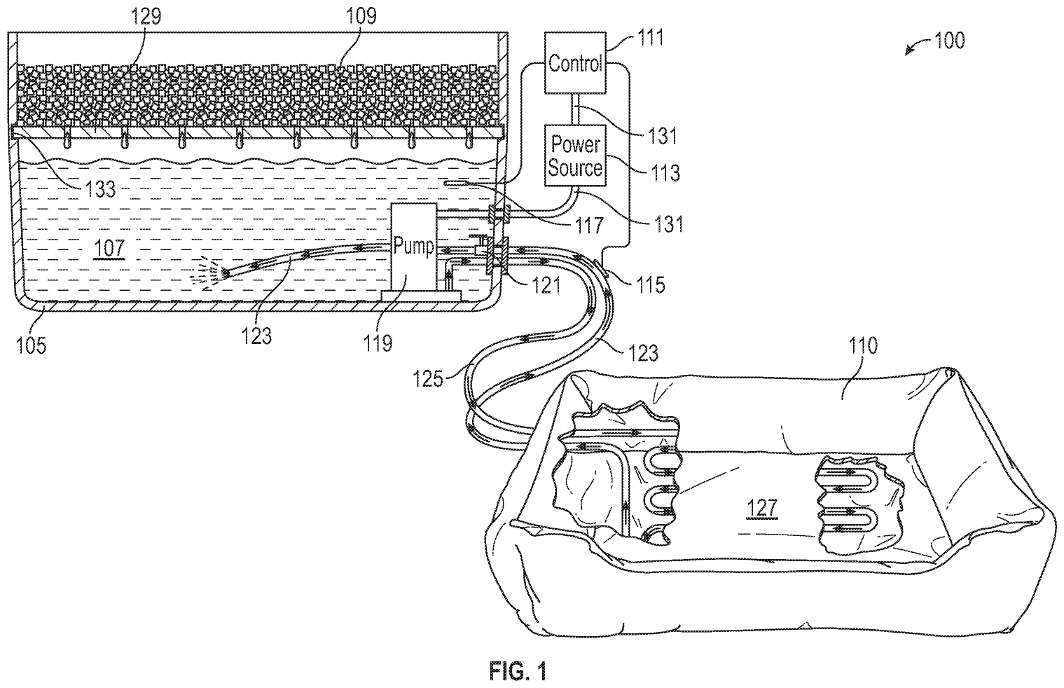

FIG. 1 illustrates an exemplary embodiment of a pet bed cooling system 100 according to the solution. As can be understood from the FIG. 1 illustration, a portable ice chest or cooler 105 may be configured or retrofitted to receive a false bottom surface 129 that operates to define a reservoir beneath the false bottom surface 129 and an ice storage volume above the false bottom surface 129. Notably, although the exemplary embodiment of a cooler 105 shown in the FIG. 1 illustration includes a sidewall groove aspect 133 for supporting the false bottom surface 129, it is envisioned that other embodiments may support a false bottom surface 129 within the cooler by use of, for example, one or more vertical leg components beneath the false bottom surface 129. In such embodiments, the one or more leg components may be separate components from the false bottom surface 129 or, optionally, may be integral to the false bottom surface 129. It is further envisioned that although the exemplary embodiment of a cooler 105 shown in the FIG. 1 illustration includes a sidewall groove aspect 133 for supporting the false bottom surface 129, other embodiments may support a false bottom surface 129 within the cooler 105 by use of, for example, one or more ledges or protrusions extending from the interior wall of the cooler 105.

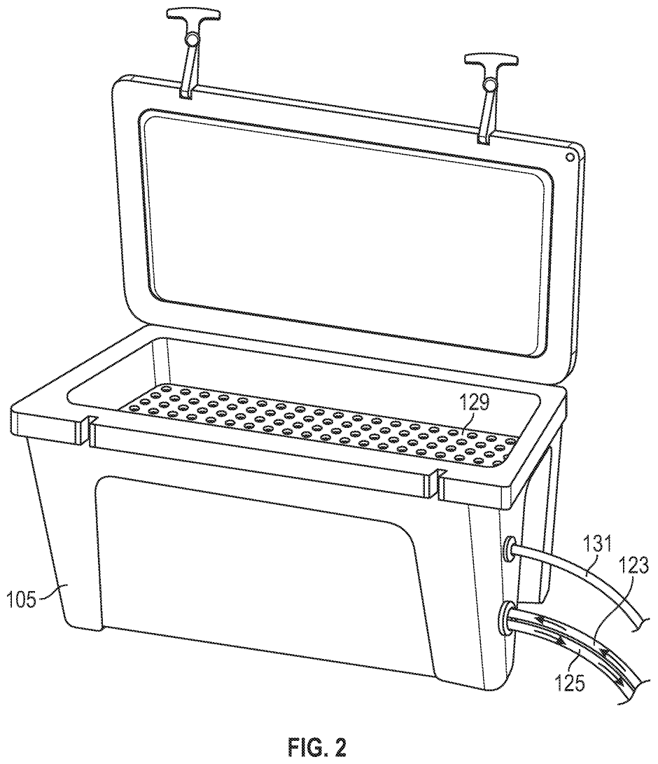

Returning to the FIG. 1 illustration, ice 109 may be placed on top of the false bottom surface 129 such that it is stored in the upper volume defined within the cooler 105 and above the false bottom surface 129. Drinks and food products may also be stored in the upper volume to be kept cool or frozen by the ice 109, as would be understood by users of portable ice chests. As the ice 109 melts, water produced from the melting process may drain through a plurality of holes in the false bottom surface 129 (perhaps better seen and understood from the FIG. 2 illustration) in collect in a reservoir 107 defined by a lower volume beneath the false bottom surface 129. As would be understood and expected by users of portable ice chests, the collected water in the reservoir 107 may be relatively cold.

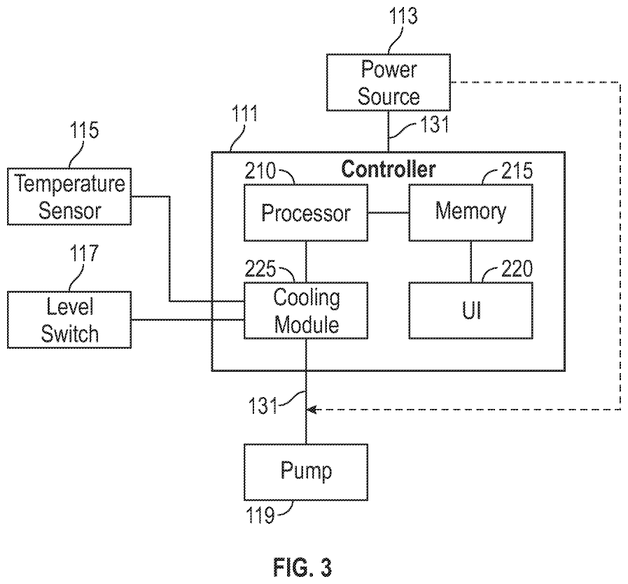

Advantageously, a pump 119 located within the reservoir 107, such as a sump pump, may be positioned and configured to circulate the cold water out of the reservoir 107, through a heat exchanger subsystem comprised of tubing or the like in a pet bed 110, and back to the reservoir 107. More specifically, the pump 119 may be powered from a power source 113. The power source may be controlled by a controller 111 such that the pump 119 may be modulated to vary a flow rate of the water, as would be understood by one of ordinary skill in the art, and/or cycle between on and off states. The controller 111 may be configured to receive one or more sensor inputs, such as from a water level switch 117 and/or a temperature sensor 115, for determining a pumping speed. The controller 111, and envisioned exemplary control schemes implemented by the controller 111, will be described in more detail below relative to the FIG. 3 illustration. It should be noted, however, that even though the exemplary embodiments of the solution 100 include a controller 111 configured and operable to vary a water flow rate through the heat exchanger subsystem, it is envisioned that other embodiments of the solution may simply leverage an on/off power switch triggered by a water level float switch or, in other embodiments, just a manually actuated on/off power switch.

The power source 113 may be an alternating current (“AC”) power source such as the type that may be accessed by a two-prong or three-prong “plug” into a standard power outlet. It is envisioned, however, that preferred embodiments of the solution may leverage a battery powered, direct current (“DC”) power source 113. In some preferred embodiments, the power source 113 may comprise a rechargeable battery pack and a solar panel component for continuous recharging the battery pack. Other preferred embodiments may simply leverage a rechargeable battery pack as the power source 113.

One or more isolation valves 121 may be included in certain embodiments of the solution for isolating output and return lines 123, 125. In operation, the pump 119, powered by the power source 113 according to a control scheme implemented by the controller 111, may supply cold water from the reservoir 107 to the pet bed 110 via an output line 125. The output line 125 may serpentine through an interior volume of the pet bed 110 and, upon exiting the pet bed 110, effectively become the return line 123 that returns the water to the reservoir 107. It is envisioned that one or more portions of the lines 123, 125 may be comprised of a flexible, thermally conductive tubing made of, for example, a thermally conductive fluoropolymer (e.g., a fluorinated ethylene propylene or a PerFluoroAlkoxy copolymer). In some embodiments, the portions of the tubing 123, 125 within the confines of the pet bed 110 structure may be comprised of thermally conductive tubing while portions of the tubing outside the pet bed 110 may be comprised of thermally insulating tubing.

Also, it is envisioned that the pet bed 110 may incorporate a thermally conductive surface 127 in mechanical connection to the lines 123, 125 such that thermal energy generated by a pet lounging in the pet bed 110 is efficiently distributed and transferred to the water circulating through the lines 123, 125. It is envisioned that the thermally conductive surface 127 may include a thin flexible metal sheet and/or a thermally conductive fabric that incorporates conductive fillers and/or conductive threads. Reference in this description to the heat exchanger subsystem envisions one or more of the tubes 123, 125 and the thermally conductive surface 127.

FIG. 2 illustrates certain aspects of the system 100 shown in FIG. 1 relative to the cooler component 105. As can be seen in the FIG. 2 illustration, the power supply line 131 and the output and return lines 125, 123 enter the cooler 105 into the lower volume space beneath the false bottom surface 129. Notably, the false bottom surface 129 includes a plurality of holes, or pathways, for water to drain from the upper volume, through the false bottom surface 129, and into the reservoir defined by the lower volume within the cooler 105 and beneath the false bottom surface 129.

FIG. 3 is a functional block diagram of exemplary components of an embodiment of the solution for a pet bed cooling system 100. The power source 113 supplies power to the controller 111 and the pump 119 via power supply lines 131. Notably, the frequency of the power supplied to the pump 119, or whether and when power is supplied to the pump 119, may be dictated by the controller 111, as will be described in more detail below. The controller 111 may comprise a cooling module 225. The cooling module 225 may be executed by and from a processor 210 and a memory 215.

In this description, the term “module” is intended to refer generally to a computer-related entity, either hardware, firmware, a combination of hardware and software, software, or software in execution, unless specifically limited to a certain computer-related entity in the claims. For example, a module may be, but is not limited to being, a process running on a processor, a processor, an object, an executable, a thread of execution, a program, and/or a computer. In addition, a module may execute from various computer readable media having various data structures stored thereon, such as memory 215.

Returning to the FIG. 3 illustration, the cooling module 225 may receive input signals from a temperature sensor 115 and/or a level sensor or level switch 117. Based on the signals received from the sensors 115, 117, the cooling module 225 may cause the power supply to the pump 119 to discontinued (thereby turning “off” the pump 119) or may cause the frequency of the power supply to the pump 119 to be modulated (thereby slowing or increasing the flow rate generated by the pump 119, as would be understood by one of ordinary skill in the art of variable speed pumps).

Advantageously, the level switch 117 may provide the cooling module 225 with a signal indicative of a water level in the reservoir 107 and, based on that signal, the cooling module 225 may determine if there is sufficient amounts of water in the reservoir 107 to pump through the heat exchanger subsystem. Similarly, the temperature sensor 115 may provide the cooling module 225 with a signal indicative of a temperature associated with water in the return line 123 and, based on that temperature signal, the cooling module 225 may determine whether to increase or decrease or discontinue pumping of water through the heat exchange subsystem. A user interface “UI” 220 may provide a user of the system 100 with the ability to adjust one or more parameters used by the controller 111 to execute a control scheme in accordance with that which has been described above.

A system and method for cooling a pet bed according to the solution has been described using detailed descriptions of embodiments thereof that are provided by way of example and are not intended to limit the scope of the disclosure. The described embodiments comprise different features, not all of which are required in all embodiments of a system and method for cooling a pet bed according to the solution. Some embodiments of the solution utilize only some of the features or possible combinations of the features. Variations of embodiments of the solution that are described and embodiments of the solution comprising different combinations of features noted in the described embodiments will occur to persons of the art.

It will be appreciated by persons skilled in the art that a system and method for cooling a pet bed according to the solution is not limited by what has been particularly shown and described herein above. Rather, the scope of a system and method for cooling a pet bed according to the solution is defined by the claims that follow.

What is claimed is:

1. A system for cooling a pet bed, the system comprising:
a portable ice chest comprising a false bottom surface that defines an upper volume and a lower volume within the portable ice chest, wherein the false bottom surface comprises a plurality of holes, the upper volume is configured to store ice, and the lower volume is configured to serve as a reservoir for water that drains through said holes;
a pump located within the lower volume of the portable ice chest, wherein the pump is configured to circulate water from the lower volume of the portable ice chest, through a heat exchanger subsystem that is external to the portable ice chest, and back to the lower volume; and
a pet bed component comprising the heat exchanger subsystem.

2. The system of claim 1, further comprising a controller configured to manage a power supply to the pump.

3. The system of claim 2, wherein the controller is configured to vary a frequency of the power supply to the pump such that a speed of the pump is varied.

4. The system of claim 2, wherein the controller is configured to switch the power supply to the pump from an energized state to a non-energized state.

5. The system of claim 2, further comprising a temperature sensor in electrical communication with the controller such that the controller manages the power supply to the pump based on a signal generated by the temperature sensor.

6. The system of claim 2, further comprising a level sensor in electrical communication with the controller such that the controller manages the power supply to the pump based on a signal generated by the level sensor.

7. The system of claim 1, wherein the heat exchanger subsystem comprises a flexible, thermally conductive tubing in fluid communication with the pump.

8. The system of claim 7, wherein the heat exchanger subsystem comprises a thermally conductive surface in mechanical communication with the flexible, thermally conductive tubing.

9. The system of claim 1, further comprising one or more isolation valves.

10. A method for cooling a pet bed, the method comprising:
installing a false bottom surface in a portable ice chest such that an upper volume and a lower volume is defined within the portable ice chest, wherein the false bottom surface comprises a plurality of holes, the upper volume is configured to store ice, and the lower volume is configured to serve as a reservoir for water that drains through said holes;
electrically actuating a pump in the lower volume such that water is circulated from the lower volume of the portable ice chest, through a heat exchanger subsystem that is external to the portable ice chest, and back to the lower volume; and
wherein a pet bed component comprises the heat exchanger subsystem.

11. The method of claim 11, further comprising varying a frequency of a power supply to the pump.

12. The method of claim 11, further comprising switching a power supply to the pump from an energized state to a non-energized state.
